(19) United States
(12) Patent Application Publication
(10) Pub. No.: US 2011/0077065 A1
(43) Pub. Date: Mar. 31, 2011

(54) GAME SET WITH WIRELESSLY COUPLED GAME UNITS

(75) Inventors: Julio Sandoval, Long Beach, CA (US); George Foster, Placerville, CA (US)

(73) Assignee: RUDELL DESIGN, LLC, Torrance, CA (US)

(21) Appl. No.: 12/893,809

(22) Filed: Sep. 29, 2010

Related U.S. Application Data
(60) Provisional application No. 61/246,877, filed on Sep. 29, 2009.

(51) Int. Cl. A63F 9/24; A63F 13/06

(52) U.S. Cl. 463/3; 463/36; 463/31

(57) ABSTRACT

A game set that includes a first unit and a second unit. The first unit includes a first controller that is coupled to a first motion sensor. The first controller causes the transmission of a wireless signal in response to movement of the first unit as sensed by the first motion sensor. The second unit includes a second controller that is coupled to an input device and a speaker The second controller causes the speaker to emit a sound that is a function of an input to the input device and the wireless signals.

### CROSS-REFERENCE TO RELATED APPLICATIONS

This application claims priority to Application No. 61/246,877, filed on Sep. 29, 2009.

### BACKGROUND OF THE INVENTION

1. Field of the Invention

The present invention relates to an electronic game with game units that wirelessly communicate with each other.

2. Prior Art

There have been marketed numerous electronic games that require input from a user. By way of example, there have been marketed video games that allow one or more users to play a simulated game of football, baseball, etc. These types of video games are typically operated with software that runs on a personal computer or a dedicated play station. The games provide graphics that are displayed by a monitor and simulate a game. Player input is implemented through a controller that is either wired or wirelessly coupled to the computer/station.

Nintendo of America, Inc. has marketed a video game under the name Wii that includes use of one or more hand held units. The hand held units are wirelessly coupled to a control station. The control station provides graphical images that are displayed by a monitor and simulate a game such as baseball or tennis. The hand held units include motion sensors that sense a motion of the unit. The units transmit signals to the control station that are then processed to determine an input to the simulated game. The hand held units are not wirelessly coupled to each other.

### BRIEF SUMMARY OF THE INVENTION

A game set that includes a first unit and a second unit. The first unit includes a first controller that is coupled to a first motion sensor. The first controller causes the transmission of a wireless signal in response to movement of the first unit as sensed by the first motion sensor. The second unit includes a second controller that is coupled to an input device and a speaker The second controller causes the speaker to emit a sound that is a function of an input to the input device and the wireless signals.

### BRIEF DESCRIPTION OF THE DRAWINGS

FIG. 1 is an illustration showing a game set that includes a pair of units configured as toy tennis rackets;

FIG. 2 is an illustration showing components of the units;

FIG. 3 is a flowchart showing operation of the game set in accordance with one embodiment;

FIG. 4 is an illustration showing a game set with units configured as a baseball and a bat;

FIG. 5 is an illustration showing a game set with units configured as a football and a mat; and,

FIG. 6 is an illustration showing a game set wherein sound is transmitted through a network.

### DETAILED DESCRIPTION

Disclosed is a game set that includes a first unit and a second unit. The first unit includes a first controller that is coupled to a first motion sensor. The first controller causes the transmission of a wireless signal in response to movement of the first unit as sensed by the first motion sensor. The second unit includes a second controller that is coupled to an input device and a speaker The second controller causes the speaker to emit a sound that is a function of an input to the input device and the wireless signals. By way of example, the sound generated by the first unit may simulate a tennis ball hitting a surface. The sound generated by the second unit may simulate a racket hitting a tennis ball if the unit is moved within a certain time interval, and also with a certain motion. The game set allows the users to play a game of virtual tennis where response is based on sound and/or the visual observation of the other players movement of their unit.

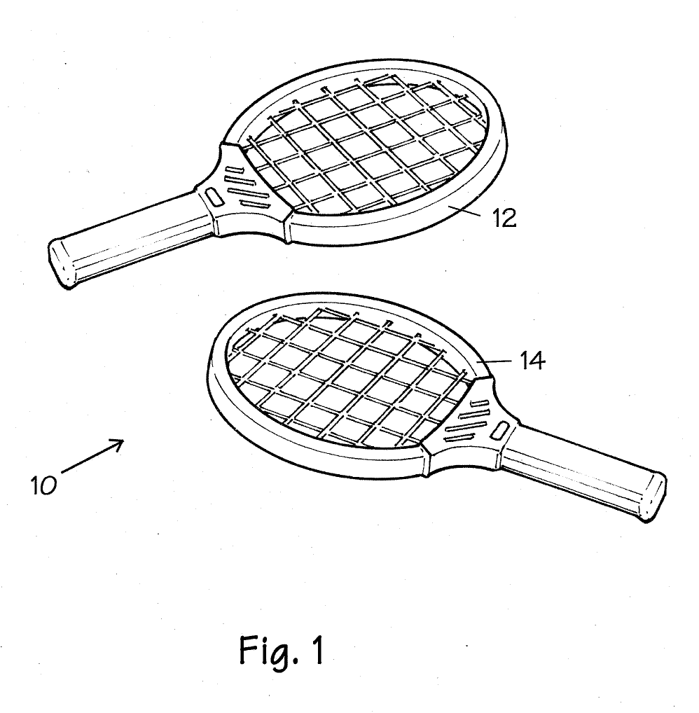

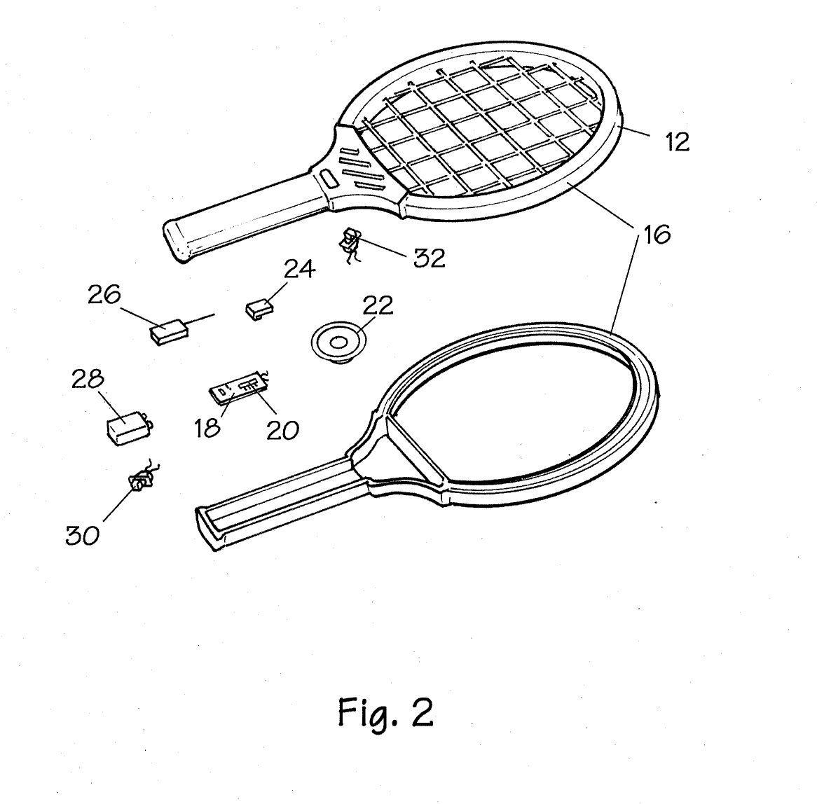

Referring to the drawings by reference numbers, FIG. 1 shows a game set 10. The game set 10 includes a first unit 12 and a second unit 14. The units 12 and 14 may be hand held devices that are configured as toy tennis rackets. FIG. 2 shows various components of each unit 12 and 14. The unit 12 or 14 includes a housing 16 shaped as a toy tennis racket. The housing 16 can be constructed from a molded plastic material. Within the housing 16 is a printed circuit board assembly 18. The printed circuit board 18 includes a controller circuit 20 and associated memory (not shown). The controller 20 may operate in accordance with software routines that are stored in memory.

The controller 20 is coupled to a speaker 22. The printed circuit board 18 may include driver circuitry (not shown) that is coupled to the speaker 22 and controller 20. The controller 20 can cause the speaker 22 to generate sound, including words and phrases. By way of example, different sounds, words, phrases, etc. may be stored in a look-up table in memory. It is to be understood that only one racket may have a speaker 20.

The controller 20 may also be coupled to a motion sensor 24 such as an accelerometer. The motion sensor 24 senses motion of the housing 16 and provides an input signal(s) to the controller 20. The controller 20 can process the input signal in accordance with a software routine.

The printed circuit board assembly 18 may include a transceiver 26 that provides two-way wireless communication between the units 12 and 14. By way of example, the wireless communication may be in the audio, radio, microwave or infrared frequency ranges.

The printed circuit board assembly 18, speaker 22 and motion sensor 24 are all powered by a battery(ies) 28. The housing 16 may include an ON/OFF button 30 and one or more input buttons 32 that can be manipulated by a user. The input buttons 32 can be coupled to the controller 20.

The units 12 and 14 can be operated to play a virtual game of tennis wherein game play is based at least in part on sound. For example, a first player may move the first unit 12 in a motion that simulates serving a tennis ball. The motion sensor 24 senses this movement and provides an input to the controller 20. The controller 20 causes the speaker 22 to emit a sound that simulates a ball traveling through air and striking a surface. The opposing player must time their swing so they move their unit and “hit” the ball in a certain time interval. The time interval is a function of the first player's swing. For example, if the first player timely makes a “hard” swing then the time interval for the second player to make a virtual return shot is shorter than if the first player has a softer swing.

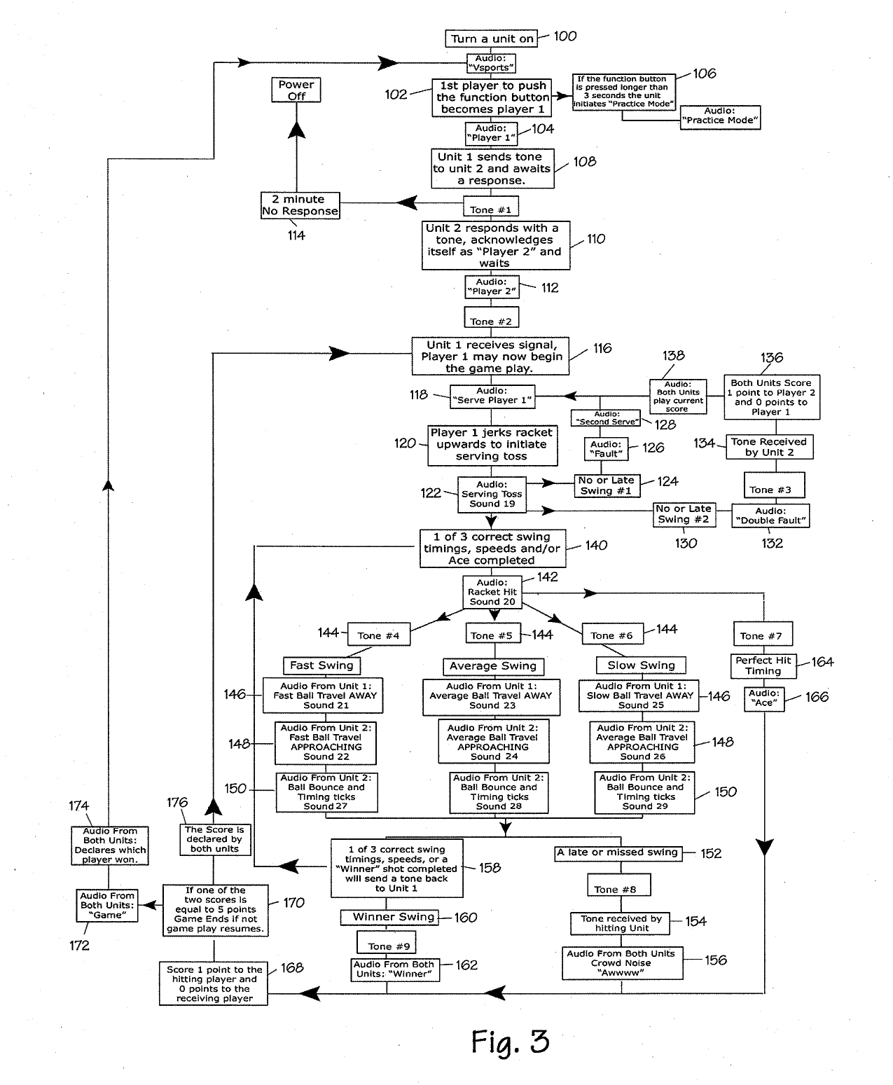

FIG. 3 is a flowchart showing a game play with the first 12 and second 14 units. In step 100 each player turns on their units by manipulating the ON/OFF button of each unit. The first player to push the input button of their unit becomes player 1 in block 102. In block 104 the first player's unit can generate a sound such as “YOU ARE PLAYER 1”. The game set may include a mode wherein a player can enter a practice subroutine if they hold the input button for longer than a predetermined time interval in step 106.

After a first player is established, the unit of the first player transmits a signal to the unit of the second player in block 108. In blocks 110 and 112 the second unit transmits a return tone to the first unit and may generate a sound such as “YOU ARE PLAYER 2”. If no tone is returned by the second unit the first unit may power off in block 114.

The first unit receives the signal from the second unit in block 116 and may generate a sound such as “SERVE” in block 118. Player 1 moves the first unit in a way that simulates tossing a tennis ball in block 120 and the unit may generate a sound that simulates the tossing of a ball in block 122. The first player then moves the first unit to simulate hitting the virtual ball. The player must swing the unit in a predetermined time interval. If there is no swing, or the swing is late, then the unit determines this in block 124 and may generate sounds such as “FAULT” and “SECOND SERVE” in blocks 126 and 128. If it is the second serve then the unit may determine this in block 130 and generate a “DOUBLE FAULT” message in block 132. In block 134 the first unit may transmit a tone to the second unit. Both units may score a point for player 2 in block 136 and generate a sound for the current score in block 138.

The first unit may determine that the first player has timely moved the unit in block 140. The first unit will then generate a sound simulating hitting a ball in block 142. In blocks 144 the first unit will generate a tone that is transmitted to the second unit. The tone will vary depending on the speed and timing of the first players movement of the first unit. For example, a fast swing in a certain time interval will generate a “fast swing” tone. An average swing will generate an “average swing” tone and a slow swing will generate a “slow swing” tone. Tones might also be generated relative to X,Y,Z axis movement of a game unit, so that a player's directional swing, to serve or respond to a serve, can effect game outcome. In an alternate embodiment a player can strategically move their racket to “place a shot” by pressing one of the buttons 32, at which time a unique sound would be generated. The units may have stereo speakers so that sound emission cues hint at left or right attitude of the virtual ball.

The game set may be configured so that the different swings have to be performed within a certain interval. For example, after tossing the ball the unit may set a time interval in which the player must swing the unit. A slow swing may be performed at any time during the interval. An average swing must be performed within the first ⅔'s of the interval and the fast swing must be accomplished within the first ⅓ of the interval. For example, a fast swing that is ½ of the set time interval will be classified as a missed swing.

In blocks 146 the first unit generates a sound that simulates a ball moving away from the player. In blocks 148 the second unit generates a sound that simulates the moving of the ball toward the second player. In block 150 the second unit generates a sound that simulates a ball hitting a surface. In block 152 the second unit determines that the second player did not timely move their unit in a motion that simulates hitting the ball. A tone is transmitted from the second unit to the first unit in block 154. Both units may generate a sound that simulates crowd noise in block 156.

In block 158 the second unit determines that the second player moved their unit in a timely manner to simulate hitting the virtual ball. The process returns to block 140 and the steps are repeated. A player may have a return shot that is determined to be a winner in block 160. A tone is sent from the winner unit to the other unit and a sound is generated by both units such as “Winner” in block 162. Likewise, a unit may determine that a player has made a perfect serve which causes a perfect hit tone to be transmitted to the other unit in block 164. Both units may generate a sound “Ace” in block 166.

In block 168 a point may be added to one of the players. The units can determine whether one of the players have reached a threshold of points in block 170. If so, then the units may generate sounds to indicate a winner in blocks 172 and 174. If not, the units generate sounds to indicate the score in block 176 and the process returns to block 116.

Table I below provides different swing and time intervals in which an opposing player must make a timely swing. For example, if one player performs an average swing the ball “travels” 1.375 second before the other unit emits a sound simulating the ball hitting the court. The opposing player has 1.145 seconds to respond. If the opposing player has a fast swing, they must time the swing between 1.725-2.075 seconds after the first player's swing. Conversely, the opposing player is provided the full response interval, 1.375-2.52 seconds if they perform a slow swing.

TABLE I

| | | | Average Approaching | Fast Approaching | Serve Timing |
|---|---|---|---|---|---|
| | Slow Approaching Sound | | Sound | Sound | During the Toss |
| Total Duration | 3.150 | Seconds | 2.520 Seconds | 1.935 Seconds | 1.084 Seconds |
| Ball Traveling Sound Before | 1.750 | Seconds | 1.375 Seconds | 1.000 Seconds | N/A |
| Player Responds | | | | | |
| Total Player Response Time | 1.400 | Seconds | 1.145 Seconds | 0.935 Seconds | 1.084 Seconds |
| Receiving Player Fast | at 2.200-2.600 | Seconds | at 1.775-2.075 | at 1.350-1.550 | 0.550-0.900 |
| Return Action | | | Seconds | Seconds | Seconds |
| Receiving Player Average | at 1.750-2.600 | Seconds | at 1.375-2.075 | at 1.000-1.550 | at 0.00-1.084 |
| Return Action | | | Seconds | Seconds | Seconds |
| Receiving Player Slow | at 1.750-3.150 | Seconds | at 1.375-2.520 | at 1.000-1.935 | at 0.00-1.084 |
| Return Action | | | Seconds | Seconds | Seconds |
| Special Return Possibilities | at 2.440-2.600 | Seconds | at 1.995-2.075 | at 1.525-1.550 | 0.820-0.900 |
| | | | Seconds | Seconds | Seconds |

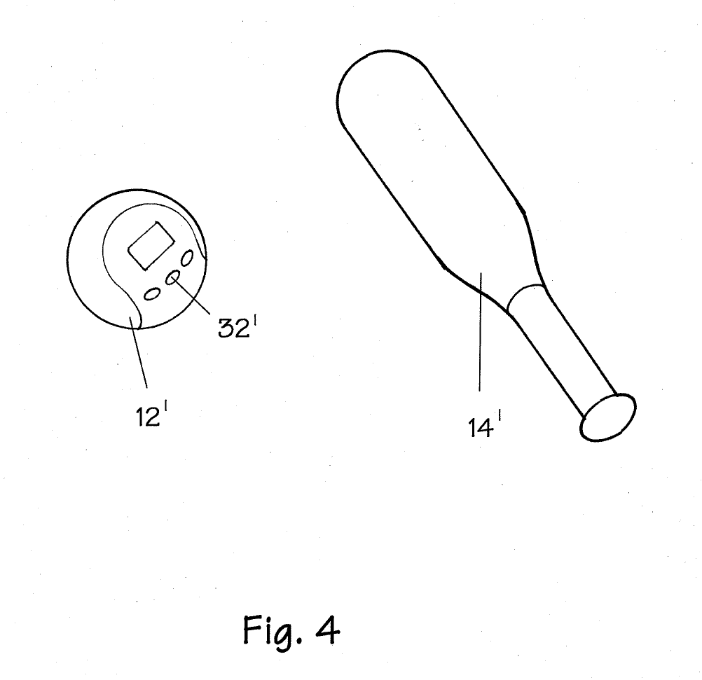

FIG. 4 shows another embodiment, wherein the units 12′ and 14′ are configured as a toy baseball and a toy bat. The toy baseball unit may include input buttons 32′ that can be selected by a user to select a type of pitch. For example, curve, fastball, slider, etc. One player can simulate throwing the ball, which could be tethered to their arm to avoid losing the ball. The ball may generate a sound simulating a ball leaving the player. The toy bat unit 14′ may generate a sound that simulates a ball coming toward the player. In an embodiment where the signal transmitted by the baseball is effected by the angle of the “pitch”, the position and attitude of the bat swing could also determine the efficacy of the result. The player with the bat unit 14′ must swing the bat in a timely manner. The time interval for timely swinging the bat can be a function of how hard the player with the baseball unit 12′ moves their arm. The bat unit 14′ can generate a sound that simulates hitting a ball. Depending on the speed and timing of swinging the bat, the bat unit may generate a sound that indicates the type of hit such as “Double”, “Home Run” or “Out”. The players can alternate use of the baseball and bat units to play a game of virtual baseball. Alternatively, the ball, instead of, or in concert with the bat unit, could generate the resultant sounds when the bat sends a signal back to the ball.

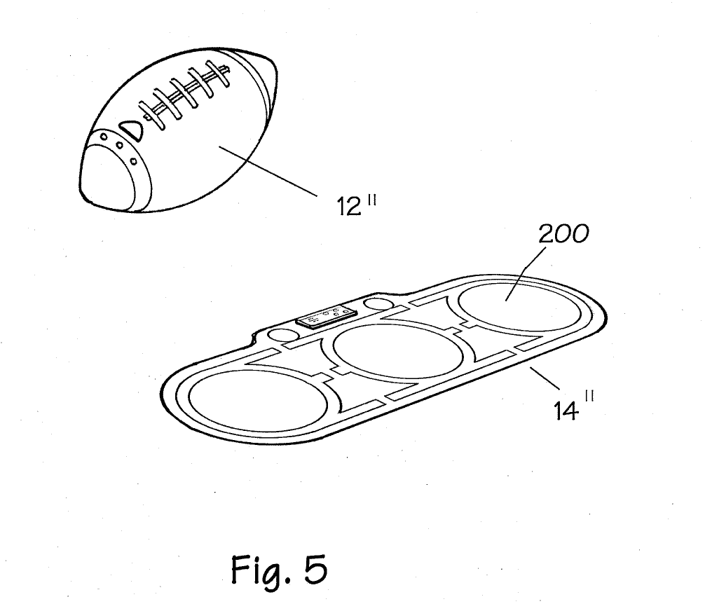

FIG. 5 shows another embodiment wherein the units 12″ and 14″ are configured as a toy football and a mat, respectively. The football unit 12″ can be moved by a player to simulate a hand-off or a pass. The mat unit 14″ may include pads 200 which contain pressure sensors (not shown). The opposing player can step on the pads to simulate running to the other player. By way of example, a player may move the football unit 12″ to simulate a hand-off. The player simulates running with the football, including changing direction, by moving the ball. Such movement is detected by a motion sensor within the ball. The opposing player steps on the mat pads 200 to simulate running toward the other player. The units 12″ and 14″ may exchange wireless signals such that the controller in one or both units determines whether the player operating the mat 14″ has “caught” the opposing player. The units may generate sounds that simulate passing, scoring, etc. Alternatively, two players may play on the same virtual team, against a virtual opponent, with the coordination of throwing the football and running and blocking as being cooperative elements against the virtual opponent.

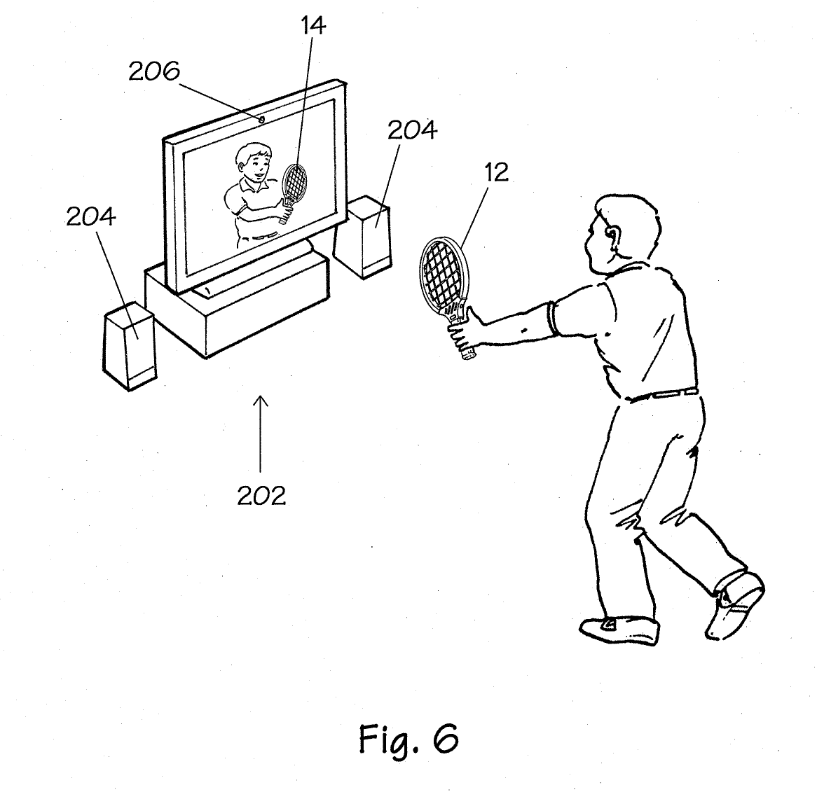

FIG. 6 shows an embodiment wherein the sounds emitted by the units are transmitted through a network such that players can be remotely located. For example, each player may be located adjacent to a computer terminal 202 that includes a microphone/speaker unit 202 and a camera 206. The sound generated by one unit is captured by the microphone at one computer station and transmitted through a network such as the Internet and then emitted by the speaker at the other computer station. By way of example, the players may establish a VoIP connection between the two computer stations. Although a computer station is shown and described, it is to be understood that other networks such as cell networks or PTSN networks can be used to transmit sound between remote players.

Although, virtual tennis, baseball and football games have been described, it is to be understood that the game set can be configured to perform other virtual game play. For example, the units can be configured as toy swords and the players can engage in a game of virtual sword play. The units may be configured as volleyballs so that the players can engage in a game of virtual volleyball. The units can be configured to be toy paintball guns. The guns may include IR emitters and detectors that are used to determine whether one player “hits” another player. The paintball gun units may generate sounds that simulate paintballs traveling through the air both away and towards the players. A player can utilize this audio clue to time the shooting of their gun, and to move their gun out of line-of-sight of the opponent's gun, to avoid a hit. Stereo speakers in the guns could assist players in determining direction of an incoming virtual paintball. The units can be configured to be toy steering wheels that contain gyroscopes that are utilized to create a simulated resistance. The units can generate sounds to simulate an opposing player approaching the other player. Each unit may have a screen with a graphical depiction of a track and vehicles moving around the track. The units may also have inputs to vary the speed of the graphical vehicle

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A game set, comprising:
a first unit that includes a first housing, said first unit includes a first controller that is coupled to first motion sensor, said first motion sensor and said first controller being coupled to a first battery, said first controller causes transmission of a wireless signal in response to movement of said first housing as sensed by said first motion sensor; and,
a second unit that includes a second housing, said second unit includes a second controller that is coupled to an input device, a speaker and a receiver that receives said wireless signal, said second sensor, said speaker, said receiver and said second controller being coupled to a second battery, said second controller causes said speaker to emit a sound that is a function of an input to said input device and said wireless signal.

2. The game set of claim 1, wherein said second controller causes said speaker to emit a sound if said first motion sensor does not sense a predetermined type of motion of said first housing within a predetermined time interval.

3. The game set of claim 1, wherein said first and second housings are adapted to be held by a human hand.

4. The game set of claim 1, wherein said input device is a second motion sensor and said second controller causes said sound in response to said second motion sensor sensing movement of said second housing.

5. The game set of claim 1, wherein said second controller causes said speaker to emit a sound if said input device does not receive an input within a predetermined time interval.

6. The game set of claim 4, wherein said predetermined time interval is a function of a motion detected by said first motion sensor.

7. The game set of claim 1, further comprising a network that transmits said sound emitted by said speaker to a user holding said first housing.

8. The game set of claim 1, wherein said first unit includes a button that is coupled to said controller.

9. The game set of claim 1, wherein said first and second units each have a transceiver.

10. The game set of claim 1, wherein said first and second housings are each configured as a toy tennis racket.

11. The game set of claim 1, wherein said first housing is configured as a toy baseball and said second housing is configured as a toy bat.

12. The game set of claim 1, wherein said first housing is configured as a toy bat and said second housing is configured as a toy baseball.

13. The game set of claim 1, wherein said first housing is configured as a toy football and second housing is configured as a mat.

14. The game set of claim 1, wherein said first housing is configured as a mat and second housing is configured as a toy football.

15. A method for playing a virtual game, comprising:
moving a first unit that includes a first controller that is coupled to a first motion sensor;
sensing the movement of the first unit with the first motion sensor;
transmitting a wireless signal that is a function of the sensed movement from the first unit;
receiving the wireless signal at a second unit that includes a second controller that is coupled to an input device and a speaker;
sensing input to the second unit; and,
generating a sound from the speaker that is a function of the wireless signal and the sensed input.

16. The method of claim 15, further comprising emitting a sound from the speaker if the first motion sensor does not sense a predetermined type of motion of the first unit within a predetermined time interval.

17. The method of claim 15, further comprising emitting a sound from the speaker if the input device does not receive an input within a predetermined time interval.

18. The method of claim 16, wherein the predetermined time interval is a function of a motion detected by the first motion sensor.

19. The method of claim 15, further comprising transmitting the sound emitted by the speaker to a user holding the first unit through a network.

20. The method of claim 15, wherein the sound generated by the speaker is a score for a game of virtual tennis.

21. The method of claim 15, wherein the sound generated by the speaker is a score for a game of virtual baseball.

22. The method of claim 15, wherein the sound generated by the speaker is a score for a game of virtual football.

23. The method of claim 15, wherein the input to the second unit is a movement of a second housing of the second unit.
